(19) United States
(12) Patent Application Publication
(10) Pub. No.: US 2007/0019663 A1
(43) Pub. Date: Jan. 25, 2007

(54) Digital broadcast receiving apparatus

(75) Inventors: Toshihiro Takagi, Daito-shi (JP); Masanori Kawai, Daito-shi (JP)

Correspondence Address: PILLSBURY WINTHROP SHAW PITTMAN, LLP, P.O. BOX 10500, MCLEAN, VA, 22102, US

(73) Assignee: Funai Electric Co., Ltd., Osaka (JP)

(21) Appl. No.: 11/475,201

(22) Filed: Jun. 27, 2006

(30) Foreign Application Priority Data
Jun. 27, 2005 (JP) 2005-187207

(51) Int. Cl. H04J 3/16

(52) U.S. Cl. 370/437

(57) ABSTRACT

A digital broadcast receiving apparatus is provided with an operating portion, a selected channel table, and a buffer memory. The digital broadcast receiving apparatus is also provided with a packet ID acquisition portion that executes a packet ID acquisition mode when a channel has been selected with the operating portion, and a packet extraction portion that, from before the packet ID acquisition portion acquires a packet ID, stores packets that agrees with a packet ID of the selected channel table in the buffer memory.

### CROSS REFERENCE

This Nonprovisional application claims priority under 35 U.S.C. § 119(a) on Patent Application No. 2005-187207 filed in Japan on Jun. 27, 2005, the entire contents of which are hereby incorporated by reference.

### BACKGROUND OF THE INVENTION

The present invention relates to a digital broadcast receiving apparatus that, referring to a channel table that indicates the relationship between a physical channel that has been set in advance and a broadcast program (a logical channel), finds a corresponding physical channel.

Conventionally, with a TV (television) receiver, a user can select and view a broadcast program that has been transmitted from a TV station to each home. Further, in recent years, attention has been paid to digital broadcasts, in which by performing, for example, compression of a video signal or the like or multiplexed transmission using digital compression encoding technology, a large number of programs can be effectively transmitted in a limited frequency band.

Following is a description focusing on a CATV (cable television) digital broadcast, which is representative of a digital broadcast. In a CATV digital broadcast, in Japan, for example, a maximum of four broadcast channels (logical channels) are being broadcast on each physical channel that has been assigned to the actual frequency band for CATV. Thus, in a CATV digital broadcast, the physical channel number and the logical channel number do not agree. In Japan, for example, in the CATV frequency band from 93 to 767 MHz, a total of 113 physical channels with a frequency bandwidth of 6 MHz are provided for CATV digital broadcasting. With CATV digital broadcasting, the maximum number of programs per each physical channel is four, and in all, a maximum of 452 programs can be transmitted. Accordingly, the physical channels and the broadcast programs (logical channels) do not correspond one-to-one, and so the relationship between the physical channels and the broadcast programs is such that there are not sufficient conditions to decide the broadcast programs even if the physical channels are decided.

In an actual usage method, the user looks at a CATV program list, looks up the logical channel that is transmitting a desired broadcast program, and indicates that logical channel to a CATV digital broadcast receiving apparatus with a remote control or the like. Thus, the CATV digital broadcast receiving apparatus, referring to a channel table that indicates the relationship between a physical channel that has been set in advance and the broadcast program (the logical channel), finds the corresponding physical channel. Then, the CATV digital broadcast receiving apparatus controls the tuner and makes a selection based on the physical channel that was found, and performs digital demodulation. Further, the CATV digital broadcast receiving apparatus extracts the indicated broadcast program, decompresses the video and audio and displays the program in a television. That is, in the CATV digital broadcast receiving apparatus, an operation that refers to the channel table is necessary.

The data recorded in this channel table (the channel table data) is transmitted from a CATV station whenever necessary. The channel table data includes, other than the relationship between the physical channels and the logical channels, data such as acquisition information for the logical channels. Acquisition information is, for example, a PMT_PID.

Here, the acquisition information is information for acquiring a packet ID (a packet identifier) that identifies a packet in which video/audio data or the like for the logical channel has been stored.

Also, with respect to the actual configuration, the above CATV digital broadcast receiving apparatus is provided with a storage portion that stores data, a packet extraction portion, a control portion that controls the apparatus main body, and an operating portion such as a remote control.

when a logical channel has been selected by the operating portion, The control portion executes a PID acquisition mode that refers to the acquisition information and acquires a packet ID (below, PID) from control data. The control data is, for example, PSI (program specific information)/SI (service information).

The packet extraction portion receives television broadcast signals, extracts a television broadcast signal of a physical channel that corresponds to a logical channel selected with the operating portion, and acquires a transport stream, which is digital data, by demodulating the extracted signal. Then, after the control portion has acquired the PID of the logical channel, the packet extraction portion extracts packets with which the PID agrees from the transport stream and records the packets in a buffer memory, and appropriately reads the packets from the buffer memory. Thus, video/audio data is played with a television receiver or the like.

On the other hand, the apparatus disclosed in JP 2002-247543A has been proposed.

However, with the above CATV digital broadcast receiving apparatus, when a logical channel has been selected by the operating portion, after the PID acquisition mode is executed and the PID is acquired, the packets from the transport stream with which the PID agrees is buffered. This PID acquisition requires much time. Thus, a large time lag occurs in the interval from the time that a logical channel is selected with the operating portion to the time that video, audio or the like is expressed.

Thus, in this interval, a conventional CATV digital broadcast receiving apparatus makes the user wait without playing video, audio or the like of the logical channel that has been selected with the operating portion. Accordingly, a conventional CATV digital broadcast receiving apparatus causes the user to feel irritation.

Also, in the apparatus disclosed in JP 2002-247543A as well, the PID acquisition mode is executed after a logical channel has been selected by an operating portion such as a remote control. Accordingly, same as above, this apparatus causes the user to feel irritation.

It is an object of the present invention to provide a digital broadcast receiver in which the time lag in the interval from the time that a channel is selected with the operating portion to the time that video, audio or the like is played is reduced, and the user is made to feel less irritation.

### SUMMARY OF THE INVENTION

The digital broadcast receiving apparatus according to the present invention includes an operating portion that selects a channel, and a control data acquisition portion that acquires control data transmitted from a broadcast station. In this configuration, the digital broadcast receiving apparatus is, for example, a CATV digital broadcast receiving apparatus or a digital TV receiver. The control data is, for example, PSI (program specific information)/SI (service information).

The digital broadcast receiving apparatus is also provided with a channel table in which, based on the control data acquired by the control data acquisition portion, a channel and acquisition information for acquiring a packet ID (below, PID) that identifies a packet of that channel are stored associated with each other, and these are newly stored when television broadcast signals are received. In this configuration, the channel table is a VCT (virtual channel table). The acquisition information is, for example, a PMT_PID. PMT_PID is the PID of a packet containing PMT (program map table) data. Here, the PMT data is included in the control data. A PID that identifies a packet containing video/audio data or the like of a logical channel is recorded in the PMT data.

The digital broadcast receiving apparatus is also provided with a packet ID acquisition portion that, when a channel has been selected with the operating portion, executes a packet ID acquisition mode that refers to the acquisition information for the channel selected with the operating portion in the channel table and acquires a PID from the control data acquired by the control data acquisition portion.

The digital broadcast receiving apparatus is also provided with a selected channel table in which the channel selected with the operating portion and the PID acquired by the packet ID acquisition portion that corresponds to that channel are stored associated with each other.

Further, the digital broadcast receiving apparatus is provided with a buffer memory that stores packets, and a packet extraction portion that receives the television broadcast signals, extracts one of the television broadcast signals according to the channel selected with the operating portion, and acquires a transport stream from the extracted signal.

When a channel stored in the selected channel table is selected with the operating portion, the packet extraction portion and the Packet ID acquisition portion work in the following manner.

The packet extraction portion, based on a first PID, stored in the selected channel table, that corresponds to the selected channel, from before the Packet ID acquisition portion acquires the PID, extracts first packets with which the first PID agrees from the transport stream and stores the first packets in the buffer memory.

The Packet ID acquisition portion

(1) acquires a second PID by executing the PID acquisition mode, and

(2) further, judges whether or not the second PID agree with the first PID.

The packet extraction portion, when the packet ID acquisition portion judges that both of these packet IDs agree, reads the first packets stored in the buffer memory.

With this configuration, when a channel stored in the selected channel table is selected with the operating portion, the packet extraction portion accumulates packet data in the buffer memory even while the Packet ID acquisition portion is performing the second PID acquisition. Thus, the packet extraction portion can read the data stored in the buffer memory shortly after the judgment of whether or not both of the above PIDs agree. that is , video/audio data is played with a television receiver or the like shortly after the judgment.

### BRIEF DESCRIPTION OF THE DRAWINGS

FIG. 1 is a block diagram that shows the main configuration of a CATV digital broadcast receiving apparatus that is an embodiment of the present invention.

FIG. 2 shows the data structure of a transport stream.

FIGS. 3A to 3E each show the content stored in a VCT 21, a PMT 22, and a selected channel table 23.

FIG. 4 is a flowchart that shows an operation performed by a control portion in a CATV digital broadcast receiving apparatus that is an embodiment of the present invention.

FIG. 5 is a block diagram that shows the main configuration of a digital TV that is another embodiment of the present invention.

### DESCRIPTION OF THE INVENTION

Following is a description of a CATV digital broadcast receiving apparatus that is an embodiment of the present invention.

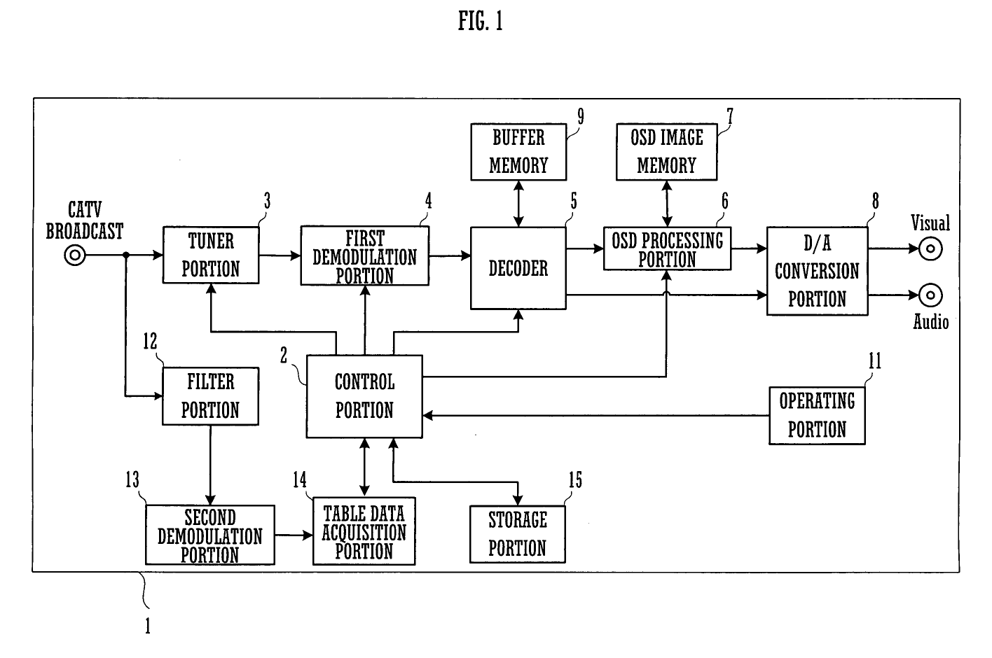

FIG. 1 is a block diagram that shows the main configuration of a CATV digital broadcast receiving apparatus that is an embodiment of the present invention.

A CATV digital broadcast receiving apparatus 1 is provided with a control portion 2 that controls each portion of the apparatus main body 1, a tuner portion 3 that receives a television broadcast signal, a first demodulation portion 4 that demodulates the received television broadcast signal into digital data, a decoder 5 that separates the demodulated digital data into video data and audio data and extends both the video data and the audio data, a buffer memory 9 that temporarily holds the digital data, an OSD processing portion 6 that combines a desired OSD (on screen display) with the video data signal, an OSD image memory 7 that stores the desired OSD, a D/A conversion portion 8 that converts the signal of the video data and the audio data into an analog signal, an operating portion 11, a filter portion 12 that performs frequency separation on the television broadcast signal, a second demodulation portion 13 that demodulates the output of the filter portion 12 into digital data, performs error correction and acquires control data, a table data acquisition portion 14 that decompresses channel table data from the acquired control data, and a storage portion 15 in which the decompressed channel table data is set.

The control portion 2 is configured with, for example, a microcomputer.

When commands such as power on/off, channel (below, when simply stating “channel”, this indicates a “logical channel”) switching, or volume control are input to the operating portion 11, the control portion 11 transmits the command to the control portion 2. The control portion 11 includes a remote control apparatus.

The tuner portion 3 extracts one of the television broadcast signals according to a physical channel that corresponds to a channel selected by the control portion 2 from the television broadcast signals transmitted from the CATV station, and outputs that extracted television broadcast signal.

The first demodulation portion 4 demodulates the television broadcast signal output from the tuner portion 3 into a transport stream, which is digital data, and outputs that transport stream.

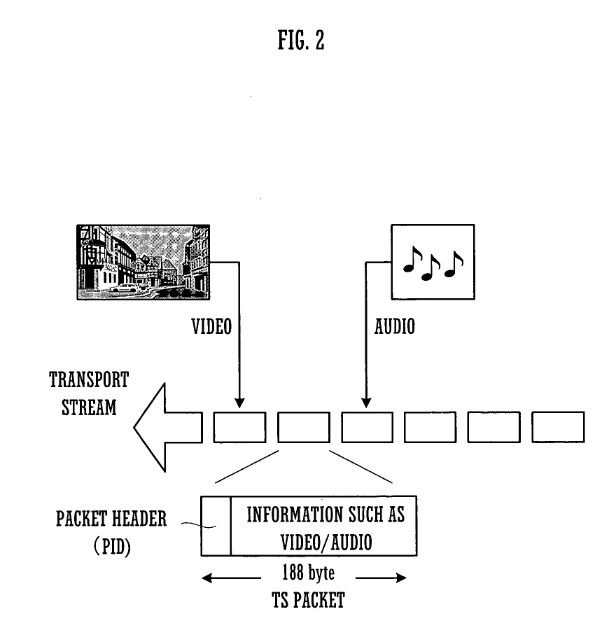

FIG. 2 shows the data structure of a transport stream.

A transport stream (TS) is a signal string of continuous TS packets (each with a fixed length of 188 bytes), and as shown in FIG. 2, a plurality of programs are multiplexed. The TS packet header (with a fixed length of 4 bytes) includes a packet identifier (below, PID) that indicates the TS packet type. From this PID, even if it is mixed into in the TS, the CATV digital broadcast receiving apparatus 1 can identify the TS packet type, such as whether those TS packets are video or audio.

The decoder 5, based on the PID designated by the control portion 2, extracts packets that agree with the PID from the transport stream, which is the output of the first demodulation portion 4. The packets extracted by the decoder 5 is stored in the buffer memory 9. The transport stream is, for example, compressed with MPEG2 compression.

The decoder 5, after receiving an instruction or permission from the control portion 2, appropriately reads the packets stored in the buffer memory 9. Then, the decoder 5 separates the read packets into video data and audio data, extends both the video data and the audio data, and outputs that data.

The video data signal output from the decoder 5 is input to the D/A conversion portion 8 via the OSD processing portion 6.

The OSD processing portion 6, based on the control signal received from the control portion 2, combines video based on the video data and characters or graphics stored by the OSD image memory 7.

The D/A conversion portion 8 converts the video data signal output by the decoder 5 into an analog video signal, and outputs that analog video signal to outside (such as a television).

Also, the D/A conversion portion 8 converts the audio data signal output by the decoder 5 into an analog audio signal, and outputs that analog audio signal to outside (such as a television).

In this embodiment the D/A conversion portion 8 is provided, but when externally connecting a television that is compatible with a digital signal, a digital signal is output as-is.

On the other hand, the filter portion 12 performs frequency separation on the television broadcast signal transmitted from the CATV station, and outputs that signal.

The second demodulation portion 13 demodulates the output of the filter portion 12 into digital data, performs error correction, acquires control data, and outputs that data. The control data is PSI (program specific information)/SI (service information).

The table data acquisition portion 14 acquires channel table data from the control data acquired by the second demodulation portion 13, and outputs that data.

This channel table data is included in the control data that is transmitted from the CATV station whenever necessary. The channel table data includes, other than the relationship between the physical channels and the logical channels, data such as the logical channel acquisition information. The acquisition information is information for acquiring a PID (a packet identifier) that identifies a packet in which video/audio data or the like for the logical channel has been stored. The acquisition information is, for example, PMT_PID. PMT_PID is the PID of a packet in which PMT (program map table) data has been stored.

Here, PMT data is included in the control data that is transmitted from the CATV station whenever necessary. In the PMT data, a PID is recorded that identifies packets that contain video/audio data and the like of a logical channel. The above PMT_PID is recorded in the header of a packet that contains the PMT data.

The PMT data is included in the control data that is transmitted from the CATV station whenever necessary. In the PMT data, a PID is recorded that identifies packets that contain video/audio data and the like of a logical channel.

The storage portion 15 is configured with, for example, an EEPROM.

The storage portion 15 is divided into three partitions, and is configured from a VCT (virtual channel table) 21, a PMT 22 and a selected channel table 23. In the VCT 21, the channel table data output by the table data acquisition portion 14 is set.

There are two VCT formats, a general-purpose SVCT (short form virtual channel table) and an expanded LVCT (long form virtual channel table). In this embodiment, the former format is adopted, and only the main parts thereof are described.

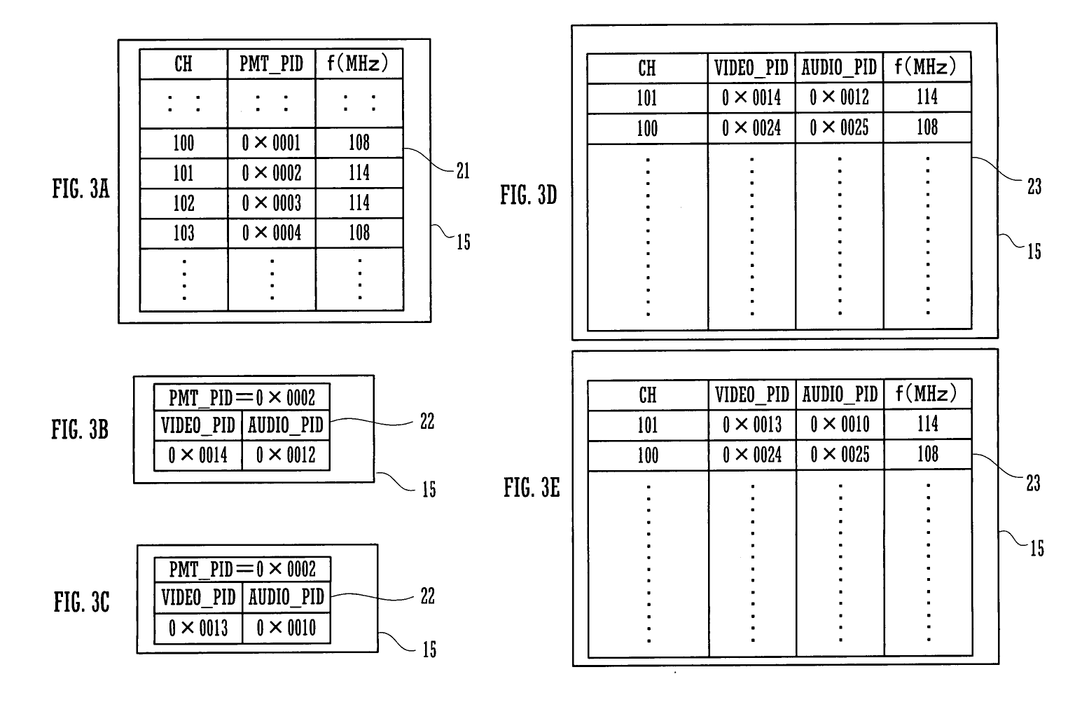

FIGS. 3A to 3E show the content stored in the VCT 21, the PMT 22, and the selected channel table 23. FIG. 3A shows the content stored in the VCT 21. FIG. 3B shows the content stored in the PMT 22 before the video and audio PID is changed. FIG. 3C shows the content stored in the PMT 22 after the video and audio PID has been changed. FIG. 3D shows the content stored in the selected channel table 23 before the video and audio PID is changed. FIG. 3E shows the content stored in the selected channel table 23 after the video and audio PID has been changed.

In the VCT 21, as shown in FIG. 3A, logical channels and the PMT_PIDs for those channels are stored associated with each other, based on the channel table data (control data) . In the VCT 21, the relationship between logical channels and demodulation frequencies are also stored.

When a channel has been selected with the operating portion 11, the control portion 2 refers to the PMT_PID of the channel that has been selected with the operating portion 11 in the VCT 21, and extracts a packet with which the PMT_PID agrees from the control data acquired by the second demodulation portion 13. PMT data is contained in that packet. Then, the control portion 2 records the PMT data in the PMT 22. Here, the control portion 2 acquires the PID from the PMT data..

Thus, as shown in FIG. 3B, a PID that identifies a packet containing the video/audio data of the logical channel is stored in the PMT 22.

Also, as shown in FIG. 3D, the channel selected by the user with the operating portion 11 and the PID that corresponds with that channel, acquired by the control portion 2, are stored associated with each other in the selected channel table 23 by the control portion 2. Also stored in the selected channel table 23 is the demodulation frequency that corresponds to that channel.

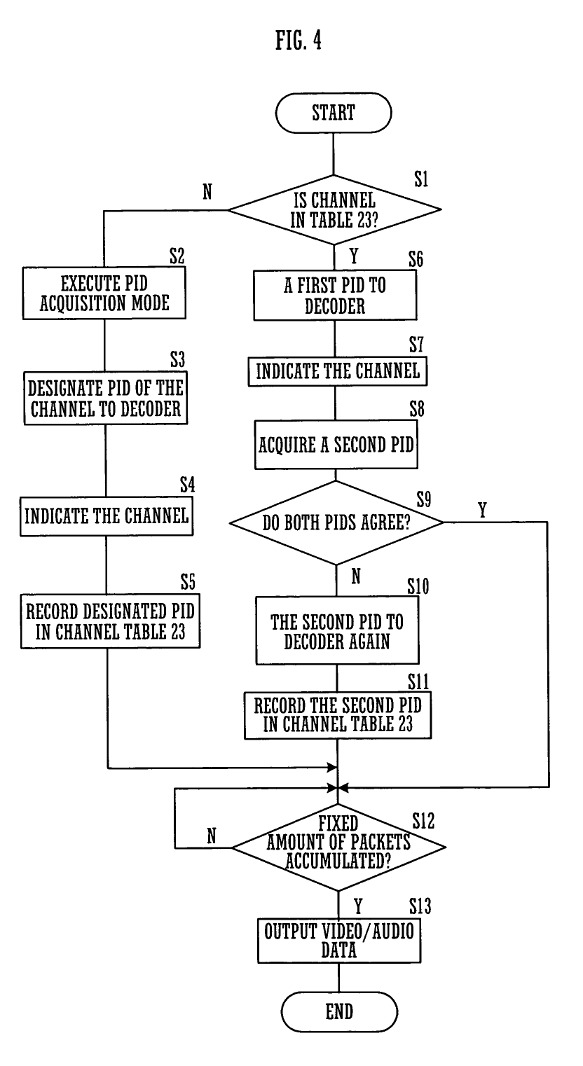

FIGS. 3C and 3E are described below in S11 in FIG. 4.

Here, VCT 21 corresponds to the “channel table” of the present invention. The selected channel table 23 corresponds to the “selected channel table” of the present invention. The control portion 2, The tuner 3, the first demodulation portion 4, and the decoder 5 correspond to the “packet extraction portion” of the present invention. The filter portion 12 and the second demodulation portion 13 correspond to the “control data acquisition portion” of the present invention. The control portion 2 corresponds to the “packet ID acquisition portion” of the present invention.

FIG. 4 is a flowchart that shows an operation performed by the control portion in the CATV digital broadcast receiving apparatus that is an embodiment of the present invention. This operation is performed when the user has selected a channel with the operating portion 11.

When a channel is selected with the operating portion 11, the control portion 2 judges whether or not the selected channel is a channel that is stored in the selected channel table 23 (S1).

When the control portion 2 judges that the selected channel is not a channel that is stored in the selected channel table, it executes a PID acquisition mode (S2). In the PID acquisition mode, the control portion 2 refers to the PMT_PID of the channel that has been selected with the operating portion 11 in the VCT 21, extracts a packet with which the PMT_PID agrees from the control data acquired by the second demodulation portion 13, and acquires a PID from the PMT data of the packet. PMT data is contained in that packet.

Following is a specific description of the PID acquisition mode in S2. When 101CH is selected with the operating portion 11, the control portion 2 refers to the PMT_PID (0x0002) for 101CH in VCT 21 (see FIG. 3A) . Then, the control portion 2 extracts a packet with which the PMT_PID (0x0002) agrees from the control data acquired by the second demodulation portion 13 (see FIG. 3B). A PID is acquired from the PMT data of the packet. Here, the PID (video_PID) of a packet that contains video data is 0x0014, and the PID (audio_PID) of a packet that contains audio data is 0x0012 (see FIG. 3B).

The control portion 2 designates the acquired PID to the decoder 5 (S3). In addition, it indicates the demodulation frequency of the selected channel to the tuner portion 3 and the first demodulation portion 4 (S4).

Thus, based on the PID designated by the control portion 2, the decoder 5 extracts a packet with which the PID agrees from the transport stream, which is the output of the first demodulation portion 4, and stores the data contained in the extracted packet in the buffer memory 9.

Next, as shown in FIG. 3D, the control portion 2 stores the channel selected by the user with the operating portion 11 and the PID that corresponds with that channel, acquired by the control portion 2, associated with each other in the selected channel table 23 (S5). In addition, the control portion 2 also records the demodulation frequency that corresponds to that channel in the selected channel table 23, in association with that channel.

The control portion 2 waits for a fixed amount of packets (for example, 10 screens worth of data) to accumulate in the buffer memory 9 (S12), permits the decoder 5 to read the packets stored in the buffer memory 9 (S13), and ends this processing.

Thus the decoder 5 appropriately reads the packets stored in the buffer memory 9. Then, the decoder 5 separates the read packets into video data and audio data, extends both the video data and the audio data, and outputs that data.

By performing the above operation, video/audio data is played with a television receiver or the like.

The processing in S2 to S4, S12, and S13 is also performed in a conventional CATV digital broadcast receiving apparatus.

However, after a logical channel is selected by the operating portion 11, and the PID acquisition mode is executed and a PID is acquired, in a conventional CATV digital broadcast receiving apparatus, a packet with which the PID agrees is extracted from the transport stream and recorded in the buffer memory. As stated above, this PID acquisition requires much time. Thus, a large time lag occurs in the interval from the time that a logical channel is selected with the operating portion 11 to the time that video, audio or the like is played.

Thus, in this interval, a conventional CATV digital broadcast receiving apparatus makes the user wait without playing video, audio or the like of the logical channel that has been selected with the operating portion 11. Accordingly, a conventional CATV digital broadcast receiving apparatus causes the user to feel irritation.

Accordingly, in this embodiment, using the content recorded in the selected channel table 23 in above S5, the time lag is reduced, and the user is made to feel less irritation.

First, in S1, when a channel stored in the selected channel table 23 is selected with the operating portion 11, the control portion 2 extracts a first PID (a first packet ID) that corresponds to the selected channel from the selected channel table 23, and indicates that first PID to the decoder 5 (S6). In addition, the control portion 2 indicates the demodulation frequency of the selected channel to the tuner portion 3 and the first demodulation portion 4 (S7).

For example, when 101CH is selected with the operating portion 11, the control portion 2 indicates a PID 0x0014 (video_PID) of a packet that contains video data, and a PID 0x0012 (audio_PID) of a packet that contains audio data (see FIG. 3B). In addition, the control portion 2 indicates that the demodulation frequency is 114 MHz to the tuner portion 3 and the first demodulation portion 4.

Due to S6 and S7, from before the control portion 2 acquires the second PID, (see S8, described below), the decoder 5, based on the first PID of the selected channel table 23, extracts first packets with which the first PID agrees from the transport stream, and stores the first packets in the buffer memory 9.

Then, the control portion 2 executes the PID acquisition mode (S8) and acquires a second PID (a second packet ID). During this processing as well, the decoder 5 stores the first packets in the buffer memory 9.

The control portion 2 judges whether or not the first PID extracted from the selected channel table 23 in S6 and the second PID acquired in S8 agrees (S9).

For example, when the first PID extracted from the selected channel table 23 in S6 is video_PID=0x0014, audio_PID=0x0012 (see FIG. 3D), and the second PID extracted in S8 is video_PID=0x0014, audio_PID=0x0012 (see FIG. 3B), the control portion 2 judges that both PIDs are in agreement.

Conversely, when the first PID extracted from the selected channel table 23 is video_PID=0x0014, audio_PID=0x0012 (see FIG. 3D), and the second PID extracted in S8 is video_PID=0x0013, audio_PID=0x0010 (see FIG. 3C), the control portion 2 judges that both PIDs are not in agreement. When both PIDs are not in agreement, a case is presumed in which there was a change in the PID that was previously recorded in the selected channel table 23 due to circumstances of the broadcast station or the like.

When it is judged that both PIDs are in agreement, the control portion 2 waits for a fixed amount of the first packets to accumulate in the buffer memory 9 (S12), permits the decoder 5 to read the first packets stored in the buffer memory 9 (S13), and ends this processing. Thus, the decoder 5, same as above, appropriately reads the first packets stored in the buffer memory 9. Thus, video/audio data is played with a television receiver or the like.

In S12, the decoder 5 accumulates the first packets in the buffer memory 9 also while the control portion 2 is performing the processing is S8 and the judgment in S9, and so video/audio data is played by the television receiver or the like shortly after an affirmative judgment in S9. In this embodiment, the time lag from the time that a channel is selected with the operating portion 11 to the time that video, audio or the like is played is reduced in comparison to a conventional digital broadcast receiver, in which after the PID mode is executed and a PID is acquired, a packet with which the PID agrees is extracted from the transport stream and buffered.

By performing the above operation, it is possible to reduce the time lag from the time that a channel is selected with the operating portion 11 to the time that video, audio or the like is played, and so the user is made to feel less irritation.

On the other hand, in S9, when it is judged that both PIDs are not in agreement, the control portion 2 designates the second PID acquired in S8 to the decoder 5 (S10). That is, the second PID is designated to the decoder 5 again. Thus the decoder 5 extracts second packets with which the second PID agrees from the transport stream, and stores the second packets in the buffer memory 9.

Next, the control portion 2 newly records the selected channel table 23 with the second PID acquired in S8 (S11). For example, when the first PID extracted from the selected channel table 23 in S6 is video_PID=0x0014, audio_PID=0x0012 (see FIG. 3D), and the second PID extracted in S8 is video_PID=0x0013, audio_PID=0x0010 (see FIG. 3C), the control portion 2 newly records the selected channel table 23 with video_PID=0x0013, audio_PID=0x0010 (see FIG. 3E).

Then, the control portion 2 waits for a fixed amount of the second packets to accumulate in the buffer memory 9 (S12), permits the decoder 5 to read the second packets stored in the buffer memory 9 (S13), and ends this processing.

Thus, the decoder 5, same as described above, appropriately reads the second packets stored in the buffer memory 9. Thus, audio/video data is played with a television receiver or the like.

In this embodiment, in S5, only a channel selected by the user with the operating portion 11 and the PID that corresponds to that channel are stored in the selected channel table 23. However, in S5, not only a channel selected by the user with the operating portion 11, but also a channel with the same demodulation frequency as the selected channel and a third PID that corresponds to the channel with that same demodulation frequency may also be stored in the selected channel table 23. For example, if the user selected channel “101”, channel “102” with the same demodulation frequency as “101” and the PID that corresponds to “102” are also stored in the selected channel table 23 (FIG. 3A and FIG. 3D). In order to achieve this, the control portion 2 performs an operation as follows. In S2, the control portion 2 refers to the VCT 21 for the PMT_PID of a channel for which the demodulation frequencies of the selected channel and the television broadcast signal are the same. Further, in S2, the control portion 2 extracts a packet with which the PMT_PID agrees from the control data acquired by the second demodulation portion 13, and acquires the third PID from the PMT data of that packet. Then, in S5, the control portion 2 records a channel with the same television broadcast signal demodulation frequency as the selected channel, and the third PID that corresponds to that channel with the same demodulation frequency, associated with each other in the selected channel table 23.

By performing the above operation, by the user only selecting one channel with the operating portion 11, a channel with the same television broadcast signal demodulation frequency as the selected channel, and a PID that corresponds to that channel with the same demodulation frequency, are stored associated with each other in the selected channel table 23.

Thus, other than the PID of the channel selected by the user with the operating portion 11, it is also possible to store the PIDs of many channels in the selected channel table 23. Accordingly, with many channels, it is possible to reduce the time lag from the time that a channel is selected with the operating portion 11 to the time that video, audio or the like is played, and so the user is made to feel less irritation

Following is a description of a digital TV that is another embodiment of the present invention.

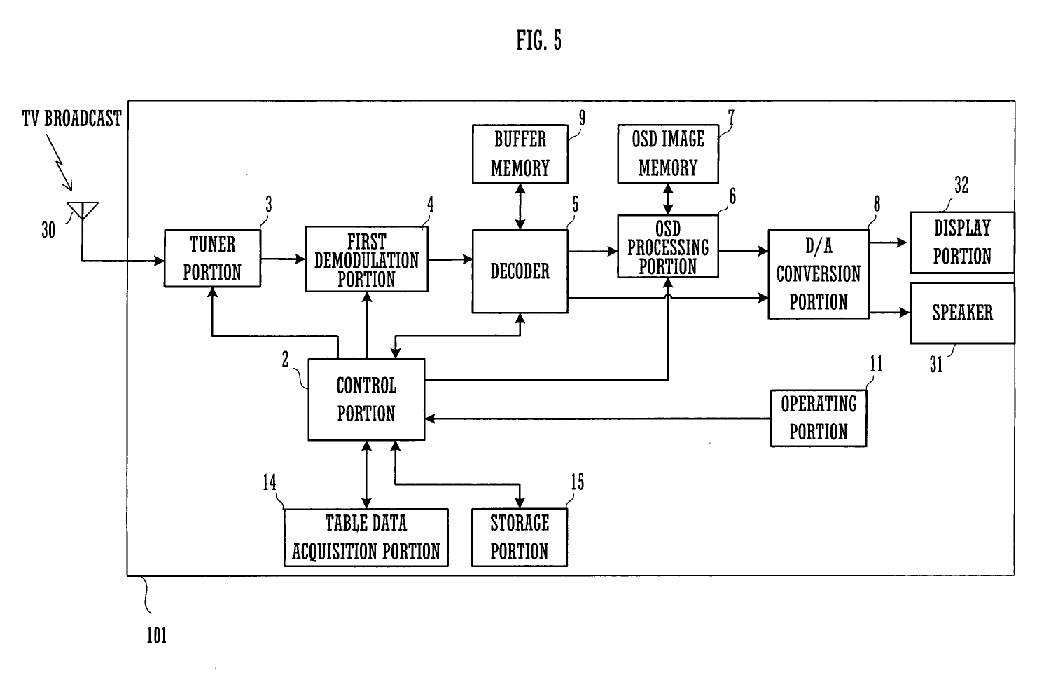

FIG. 5 is a block diagram that shows the main configuration of the digital TV that is another embodiment of the present invention.

A digital television (TV) 101, in comparison to the CATV digital broadcast receiving apparatus 1 in FIG. 1, has a configuration in which the filter portion 12 and the second demodulation portion 13 are not used, provided with a display portion 32 that displays video by processing the video signal converted to analog by the D/A conversion portion 8, and a speaker 31 that produces audio by processing the audio signal converted to analog by the D/A conversion portion 8. Otherwise the configuration is the same as in the CATV digital broadcast receiving apparatus 1 in FIG. 1.

On the other hand, with respect to operation, the digital TV 101 is the same as the CATV digital broadcast receiving apparatus 1 in FIG. 1.

Following is a description of the method of acquiring the control data and the channel table data used in the digital TV 101, because it differs from the method used in the CATV digital broadcast receiving apparatus 1 in FIG. 1.

The tuner portion 3 extracts the television broadcast signal according to a physical channel that corresponds to a channel selected by the control portion 2 from a television broadcast signal being received with the antenna 30, and outputs that signal.

The first demodulation portion 4 demodulates the television broadcast signal output from the tuner portion 3 into a transport stream, which is digital data, and outputs the transport stream.

The decoder 5 separates and extracts a video signal, an audio signal, and control data output from the first demodulation portion 4, and transmits the control data to the table data acquisition portion 14.

The table data acquisition portion 14 acquires channel table data from the control data acquired by the decoder 5 and outputs that data.

Same as the CATV digital broadcast receiving apparatus 1 in FIG. 1, the control data and the channel table data acquired in this way is stored in the VCT 21 and the PMT 22.

In the CATV digital broadcast receiving apparatus 1 in FIG. 1, information for all of the logical channels in the channel table is recorded, but in the case of the digital TV 101, information for the logical channels present in the physical channels that have been selected in the channel table data is recorded.

Here, the VCT 21 corresponds to the “channel table” of the present invention. The PMT 22 corresponds to the “designated channel table” of the present invention. The control portion 2, The tuner 3, the first demodulation portion 4, and the decoder 5 correspond to the “packet extraction portion” of the present invention. The control portion 2, The tuner 3, the first demodulation portion 4, and the decoder 5 correspond to the “control data acquisition portion” of the present invention. The control portion 2 corresponds to the “packet ID acquisition portion” of the present invention.

Finally, the embodiments described above are to be considered in all respects as illustrative and not limiting. The scope of the invention is indicated by the appended claims rather than by the foregoing embodiments. Furthermore, all changes which come within the meaning and range of equivalency of the claims are intended to be embraced in the scope of the invention.

What is claimed is:

1. A digital broadcast receiving apparatus comprising:
an operating portion that selects a channel;
a control data acquisition portion that acquires control data transmitted from a broadcast station;
a channel table in which, based on the control data acquired by the control data acquisition portion, a channel and acquisition information for acquiring a packet ID that identifies a packet of that channel are stored associated with each other, and these are newly stored when television broadcast signals are received;
a packet ID acquisition portion that, when a channel has been selected with the operating portion, executes a packet ID acquisition mode that refers to the acquisition information for the channel selected with the operating portion in the channel table and acquires a packet ID from the control data acquired by the control data acquisition portion;
a selected channel table in which the channel selected with the operating portion and the packet ID acquired by the packet ID acquisition portion that corresponds to that channel are stored associated with each other;
a buffer memory that stores packets; and
a packet extraction portion that receives the television broadcast signals, extracts one of the television broadcast signals according to the channel selected with the operating portion, and acquires a transport stream from the extracted signal, wherein
the packet extraction portion, when a channel stored in the selected channel table is selected with the operating portion, based on a first packet ID,stored in the selected channel table, that corresponds to the selected channel, from before the packet ID acquisition portion acquires the packet ID, extracts first packets with which the first packet ID agrees from the transport stream and stores the first packets in the buffer memory,
the packet ID acquisition portion, when a channel stored in the selected channel table is selected with the operating portion, acquires a second packet ID by executing the packet ID acquisition mode, and judges whether or not the second packet ID agree with the first packet ID, and
the packet extraction portion, when the packet ID acquisition portion judges that both of these packet IDs agree, reads the first packets stored in the buffer memory.

2. The digital broadcast receiving apparatus according to claim 1, wherein when the packet ID acquisition portion judges that both of these packet IDs do not agree, the packet extraction portion, based on the second packet ID, extracts second packets with which the second packet ID agrees from the transport stream, records the second packets again in the buffer memory, and reads the second packets stored in the buffer memory.

3. The digital broadcast receiving apparatus according to claim 1, wherein when the channel is selected with the operating portion, the packet ID acquisition portion refers to the acquisition information of a channel with the same television broadcast signal demodulation frequency as the selected channel in the channel table, and acquires a third packet ID from the control data acquired by the control data acquisition portion, and
in the channel table, a channel with the same television broadcast signal demodulation frequency as the channel selected with the operating portion, and the third packet ID acquired by the packet ID acquisition portion that corresponds to that channel with the same demodulation frequency, are stored associated with each other.
